(19) United States
(12) Patent Application Publication
(10) Pub. No.: US 2009/0112459 A1
(43) Pub. Date: Apr. 30, 2009

(54) WAYPOINT CODE ESTABLISHING METHOD, NAVIGATION STARTING METHOD AND DEVICE THEREOF

(76) Inventor: Jian-Hua Lin, MaoMing city (CN)

Correspondence Address: NORTH AMERICA INTELLECTUAL PROPERTY CORPORATION, P.O. BOX 506, MERRIFIELD, VA, 22116, US

(21) Appl. No.: 12/189,773

(22) Filed: Aug. 11, 2008

(30) Foreign Application Priority Data
Oct. 30, 2007 (CN) 200710184939.8

(51) Int. Cl. G01C 21/00

(52) U.S. Cl. 701/206

(57) ABSTRACT

A navigation starting method applied to a navigation device includes: inputting a code to the navigation device, wherein the navigation device has a plurality of target waypoint codes respectively corresponding to a plurality of target waypoints; choosing a specified target waypoint from the plurality of target waypoints according to the code and the plurality of target waypoint codes; and automatically starting a navigation operation corresponding to the specified target waypoint after the specified target waypoint is chosen.

### BACKGROUND

The present invention relates to the operating mechanism of a navigation system, and more particularly, to methods of waypoint code establishment, navigation starting method using the established waypoint codes, and related devices thereof.

Global Navigation Satellite System (GNSS) is the most popular positioning system for computing geography plane coordinate values (i.e. longitude and latitude). At present, the global navigation satellite system (i.e., GNSS) mainly includes Global Positioning System (GPS), Galileo positioning system, GLONASS, etc.

In addition, due to the popularity of various portable electronic devices, GNSS has been broadly applied to these portable electronic devices. For instance, a GNSS receiver can be combined with a navigation device to provide positioning information required by related navigation operations. However, a user must usually execute complex operations via the user interface (man-machine interface) of the navigation apparatus to select a desired target waypoint and start a navigation flow for the selected target waypoint. Therefore, a novel method for allowing the user to conveniently operate a navigation apparatus for enabling a navigation flow for a target waypoint is an important issue of the navigation system design.

### SUMMARY

According to one embodiment of the present invention, a waypoint code establishing method applied to an electronic device is disclosed. The waypoint code establishing method includes: dynamically editing a plurality of target waypoint codes and respectively assigning the plurality of target waypoint codes to a plurality of target waypoints stored within the electronic device; and storing the plurality of target waypoints codes into the electronic device.

According to another exemplary embodiment of the present invention, a navigation starting method applied to a navigation device is disclosed. The navigation method includes: inputting a code to the navigation device, wherein the navigation device has a plurality of target waypoint codes respectively corresponding to a plurality of target waypoints; choosing a specified target waypoint from the plurality of target waypoints according to the code and the plurality of target waypoint codes; and automatically starting a navigation operation corresponding to the specified target waypoint after the specified waypoint is chosen.

According to yet another exemplary embodiment of the present invention, an electronic device is disclosed. The electronic device includes a processor, a first storage unit, and a second storage unit. The second storage unit stores a waypoint code establishment program, wherein the processor executes the waypoint code establishment program to execute the following operations: dynamically editing a plurality of target waypoint codes and assigning the plurality of target waypoint codes respectively to a plurality of target waypoints; and storing the plurality of target waypoint codes into the first storage unit.

According to yet another exemplary embodiment of the present invention, a navigation device is disclosed. The navigation device includes: a processor; a first storage unit storing a plurality of target waypoint codes corresponding to a plurality of target waypoints; an input unit for receiving a code; a navigation module; and a second storage unit storing a navigation starting program. The processor executes the navigation starting method to execute the following operations: choosing a specified target waypoint from the plurality of target waypoints according to the code and the plurality of target waypoint codes; and automatically starting a navigation operation corresponding to the specified target waypoint after the specified target waypoint is chosen.

Compared to the related art, the navigation waypoint code establishing method and the navigation starting method provide a user with a new operating scheme to rapidly navigate to a wanted destination merely through inputting a target waypoint code corresponding to a target waypoint within the GIS database and then inputting a navigation confirming signal to the electronic device to start a navigation operation. As a result, the time taken for a user to execute a navigation operation for each wanted destination is significantly decreased compared to the prior art, and consequently provides the user with great operating convenience when the navigation device is in use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an exemplary embodiment of an electronic device according to the present invention.

FIG. 2 is a flowchart illustrating the waypoint code establishing method applied to the electronic device shown in FIG. 1 according to an exemplary embodiment of the present invention.

FIG. 3 is a diagram illustrating a waypoint code-editing interface displayed on the output unit of the electronic device according to an exemplary embodiment of the present invention.

FIG. 4 is a flow chart illustrating a navigation starting method applied to the electronic device shown in FIG. 1 according to an exemplary embodiment of the present invention.

FIG. 5 is a diagram illustrating an exemplary embodiment of the navigation starting method of FIG. 1 employed on a navigation device without a physical keyboard according to the present invention.

FIG. 6 is a diagram illustrating a first embodiment of applying the disclosed navigation starting method to an electronic device with a physical keyboard according to the present invention.

FIG. 7 is a diagram illustrating a second embodiment of applying the disclosed navigation starting method to an electronic device with a physical keyboard according to the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

For simplicity, in the following description, the Global Positioning System is called a GPS system for short, and the GPS system is merely one embodiment of the Global Navigation Satellite System (GNSS). In other words, in the present invention, the global navigation satellite system and the global positioning system (i.e., GPS system) are interchangeable terms. In addition, in the following description, the positioning system can employ the GPS system, a Dead Reckoning System, or both systems. Therefore, as one skilled in the art will readily appreciate, the present invention is not limited to the technical field of electronic devices using the GPS system. Furthermore, since the electronic device mentioned in the following description is implemented for executing navigation operations, the electronic device and the navigation device in the present invention hence are interchangeable terms.

The present invention discloses a waypoint code establishing method, a navigation starting method applying the established waypoint codes and related devices thereof. When a user wants to start a navigation operation toward a certain wanted destination (target waypoint), the user can input a target waypoint code through an input unit and then the navigation operation is rapidly enabled to guide the user to the wanted destination (target waypoint), wherein the target waypoint code corresponds to the target waypoint. In this way, the number of times a user makes the keystrokes and the user leafs over related operating interface when trying to enable the navigation operation is reduced greatly, thereby improving the convenience of operating the navigation device. Related description of the present invention is disclosed as follows.

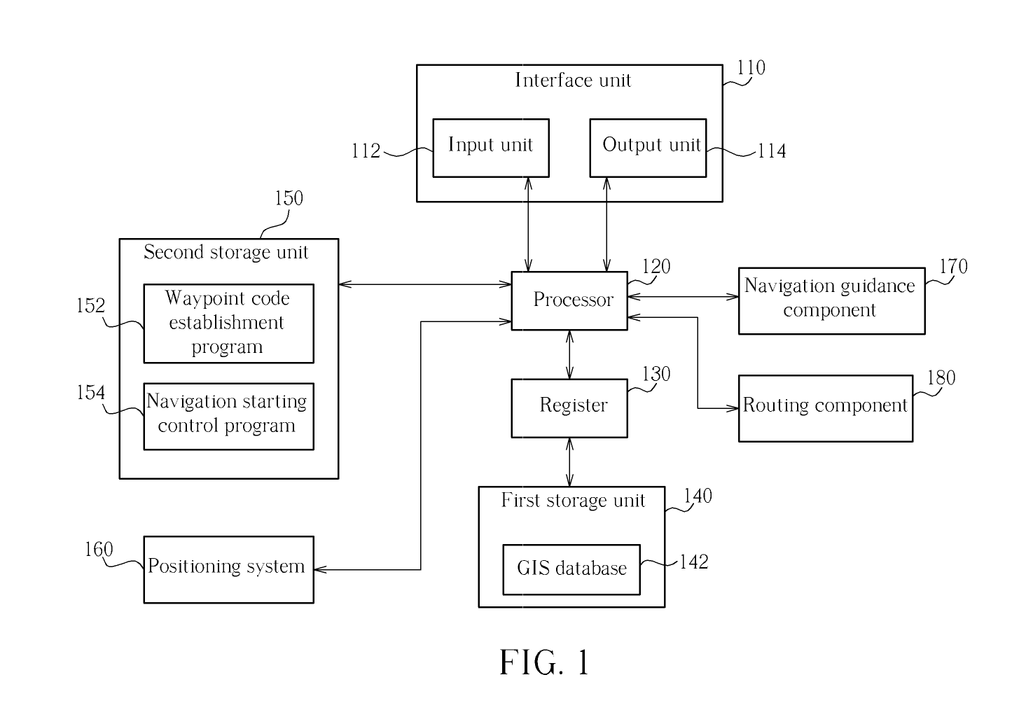

Please refer to FIG. 1. FIG. 1 is a block diagram illustrating an exemplary embodiment of an electronic device 100 according to the present invention. In this exemplary embodiment, the electronic device 100 includes an interface unit 110, a processor 120, a register 130, a first storage unit 140, a second storage unit 150, a positioning system 160, a navigation guidance component 170 and a routing component 180. In addition, the interface unit 110 contains an input unit 112 and an output unit 114, and the first storage unit 140 contains a Geographic Information System (GIS) database 142. The second storage unit 150 stores a waypoint code establishment program 152 and a navigation starting control program 154.

The input unit 112 (within the interface unit 110) is coupled to the processor 120, and is implemented for the user(s) to execute operations such as inputting waypoint codes, editing waypoint codes and/or checking the starting of the navigation, etc. For instance, the user inputs related user commands through the input unit 112 to control the processor 120 to execute dynamical editing of a plurality of target waypoints or store a plurality of target waypoint codes corresponding to the plurality of target waypoints, wherein the plurality of target waypoint codes are stored within the first storage unit 140. In addition, the user can also use the input unit 112 to start a navigation operation by inputting a target waypoint code corresponding to a specified target waypoint.

The input unit 112 can adopt different input methods such as keyboard input, vocal input and/or image input, etc. In an exemplary case, the input unit 112 can contain a touch screen, a keyboard, a microphone and/or any other device for inputting user commands to the electronic device 100.

The output unit 114 (within the interface unit 110), coupled to the processor 120, is implemented for displaying the target waypoint code inputted by the user and/or any related reminding information. For the output unit 114, data formats of the output signal can be vocal outputs, image outputs or a combination of both. In an exemplary case, the output unit 114 can contain a monitor, a speaker and/or any signal-outputting device. The register 130 is implemented for registering data transmitted between the processor 120 and the first storage unit 140.

The GIS database 142 within the first storage 140 has the required geography information demanded by the navigation guidance component 170 and the routing component 180. In addition, in this embodiment, the first storage unit 140 further stores the plurality of target waypoint codes set by the user and the related information of the corresponding target waypoints for the target waypoint codes. For instance, related information for both the plurality of target waypoint codes and for the corresponding plurality of target waypoints is stored in the GIS database 142 as well.

Furthermore, the second storage unit 150 stores the waypoint code establishment program 152 and the navigation starting control program 154 for the electronic device 100 to execute the navigation operations. In other words, the processor 120 executes the waypoint code establishment program 152 to implement the disclosed waypoint establishing method of the present invention, and the processor 120 further executes the navigation starting control program 154 to implement the disclosed navigation starting method of the present invention.

The positioning system 160 is utilized for providing position information such as the current position, the current speed and the current direction of the electronic device 100. In this exemplary embodiment, the positioning system 160 could contain the GNSS system including the GPS system, the Dead Reckoning system or a combination of both systems. The navigation guidance component 170 generates the navigation information according to information such as the current speed and current direction of the electronic device 100, and then the generated navigation information is transmitted to the output unit 114 (within the interface unit 110) for displaying. The routing component 180 is utilized to schedule the needed route information for the navigation routing and transmit the route information to the output unit 114 as outputs of the output unit 114.

It should be noted, however, that the above description is not meant to be a limitation of the present invention. That is, the components are shown as individual blocks for illustrative purposes only. Therefore, the components illustrated in FIG. 1 are not limited to be disposed in the electronic device 100 separately. Other hardware configurations obeying the spirit of the present invention are possible. Besides, related operations and structures of the interface unit, positioning system and electronic map display are known to those skilled in the pertinent art, a detailed description is therefore omitted for brevity. The functions of the electronic device 100 of the aforementioned disclosure are merely for illustrative purposes and are not limitations of the present invention; in other embodiments, the electronic device can possess additional functions and this also falls within the scope of the disclosed invention.

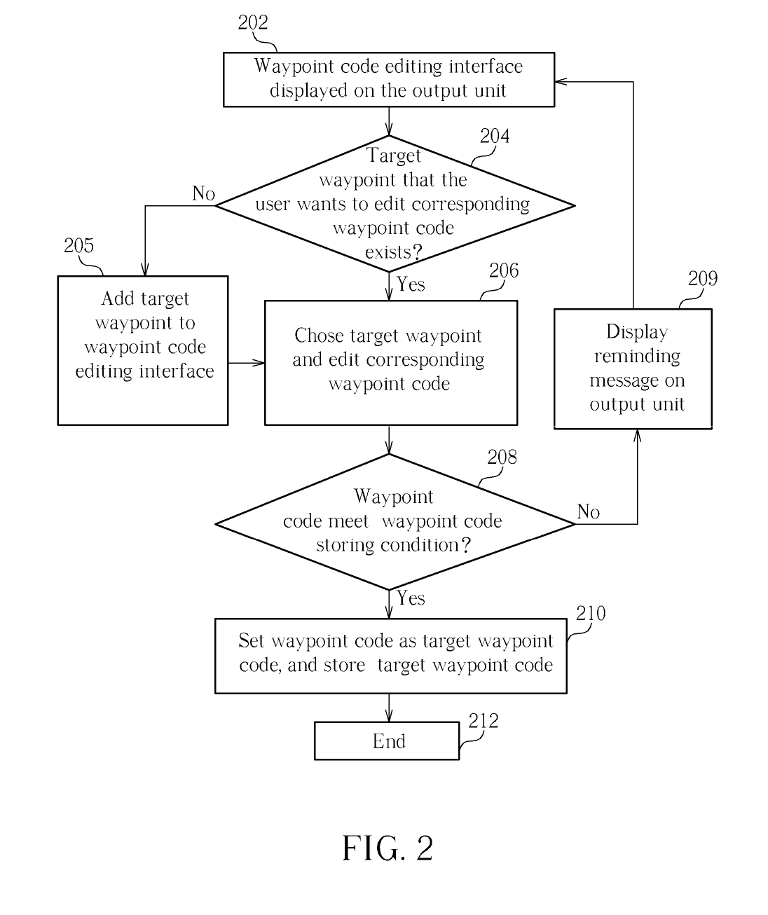

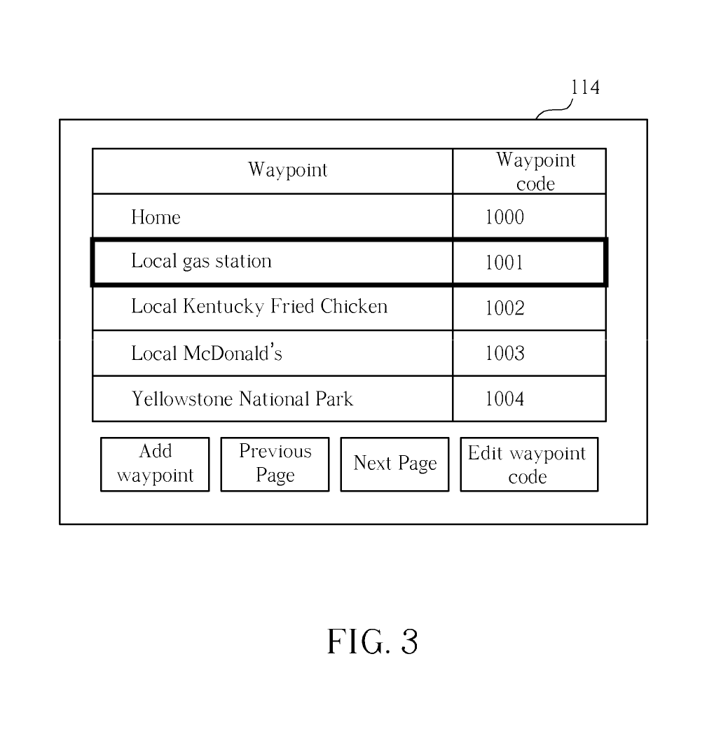

Please refer to FIG. 1-FIG. 3 together. FIG. 2 is a flowchart illustrating the waypoint code establishing method applied to the electronic device 100 shown in FIG. 1 according to an exemplary embodiment of the present invention. FIG. 3 is a diagram illustrating a waypoint code-editing interface displayed on the output unit 114 of the electronic device 100 according to an exemplary embodiment of the present invention. Please note that if the result is substantially the same, the steps are not limited to be executed according to the exact order shown in FIG. 2. The flow includes the following steps:
Step 202: Enter a waypoint code editing interface displayed on the output unit 114;
Step 204: Check if a target waypoint corresponding to a target waypoint code that the user wants to edit exists within the waypoint code-editing interface or not. If yes, go to Step 206; otherwise, go to Step 205;
Step 205: Add the target waypoint to the waypoint code editing interface by selecting the target waypoint from the first storage unit 140 through a waypoint adding function of the waypoint code editing interface, and then go to Step 206;
Step 206: Chose the target waypoint from the waypoint code editing interface and dynamically edit the waypoint code corresponding to the target waypoint accordingly;
Step 208: Determine if the waypoint code corresponding to the target waypoint meets a waypoint code storing condition or not. If yes, go to Step 210; otherwise, go to Step 209;
Step 209: Display a reminding message on the output unit 114 for informing the user of the invalid editing currently made to this waypoint code, and then go to Step 202 to allow the user to do the waypoint code editing again;
Step 210: Set the waypoint code as a target waypoint code, and store the target waypoint code into the GIS database 142 in the first storage unit 140;
Step 212: End.

In Step 202, the user uses the output unit 114 included in the interface unit 110 to enter the waypoint code editing interface for the following editing operation. When the user finds the target waypoint to be edited is not included in the waypoint code-editing interface shown in FIG. 3, the user then searches the GIS database 142 within the first storage unit 140 for the target waypoint through the waypoint adding function provided by the target waypoint code-editing interface; alternatively, the user can add the target waypoint to be edited to the waypoint code-editing interface through the GIS database 142 that is linked to a point of interest (POI) archive (not shown in FIG. 1 for simplicity). The flow then executes Step 206 to edit the waypoint code corresponding to the target waypoint dynamically.

In Step 206, the user completes the editing operation of the waypoint code corresponding to the aforementioned target waypoint. In Step 208, the processor 120 executes the waypoint code-establishing program 152 to do a validity check upon the waypoint code inputted by the user according to a waypoint code storing condition. For instance, in an exemplary case, the processor 120 may check if the waypoint code is different from all target waypoint codes already stored within the GIS database 142. That is, if there exists a target waypoint code in the GIS database 142 that is identical to the waypoint code currently edited by the user, the waypoint code will be judged as an invalid waypoint code, and the output unit 114 at this time will output reminder information for informing the user of an editing error. After receiving the user's confirmation, the flow goes back to the waypoint editing interface for proceeding with the dynamical waypoint code editing again: i.e. the flow goes back to Step 202.

In Step 208, if the waypoint code to be edited by the user is different from all the target waypoint codes stored within the GIS database 142, the processor 120 at this time further executes the waypoint code establishing program 152 to check if the waypoint code meets a predetermined waypoint code format defined by the waypoint code editing establishing program 152. That is, in this embodiment, the waypoint code storing condition includes two judgments. First, the waypoint code edited by the user must be different from all the target waypoint codes stored within the electronic device 100. Second, the waypoint code edited by the user must meet the predetermined waypoint code format. Here, please note that after the waypoint code has been verified as a valid waypoint code, the processor 120 will store the waypoint code into the storage unit (e.g., first storage unit 140) in the electronic device 100.

In this exemplary embodiment, the electronic device is a navigation device, and the valid waypoint code meeting the waypoint code storing condition will then be stored into the GIS database 142. Please note that the valid waypoint codes will be saved as the target waypoint codes for the follow-up navigation operations. In the present invention, the target waypoint codes are stored in the GIS database 142; however, this is not meant to be a limitation of the present invention. In other embodiments, the plurality of target waypoint codes can also be stored in other storage unit(s) present in the electronic device 100 or other units added to the electronic device 100.

Please note that the electronic device 100 mentioned in the following description is a navigation device for simplicity. In addition, the GIS database 142 implemented for storing target waypoint codes is included in the first storage unit 140. However, this is not meant to be a limitation of the present invention. After reading the disclosure of the present invention, a person skilled in the pertinent art would readily appreciate that other alternative designs obeying the spirit of the present invention still fall in the scope of the present invention.

After Step 210, the electronic device 100 will properly store the target waypoint code edited by the user into the GIS database 142. In an exemplary case, when there are other target waypoint(s) that the user still wants to edit, the flow will go back to Step 202 for repeating the above-mentioned waypoint code establishing process. Since the waypoint code establishing method has been detailed in the above description, further description is omitted here for brevity.

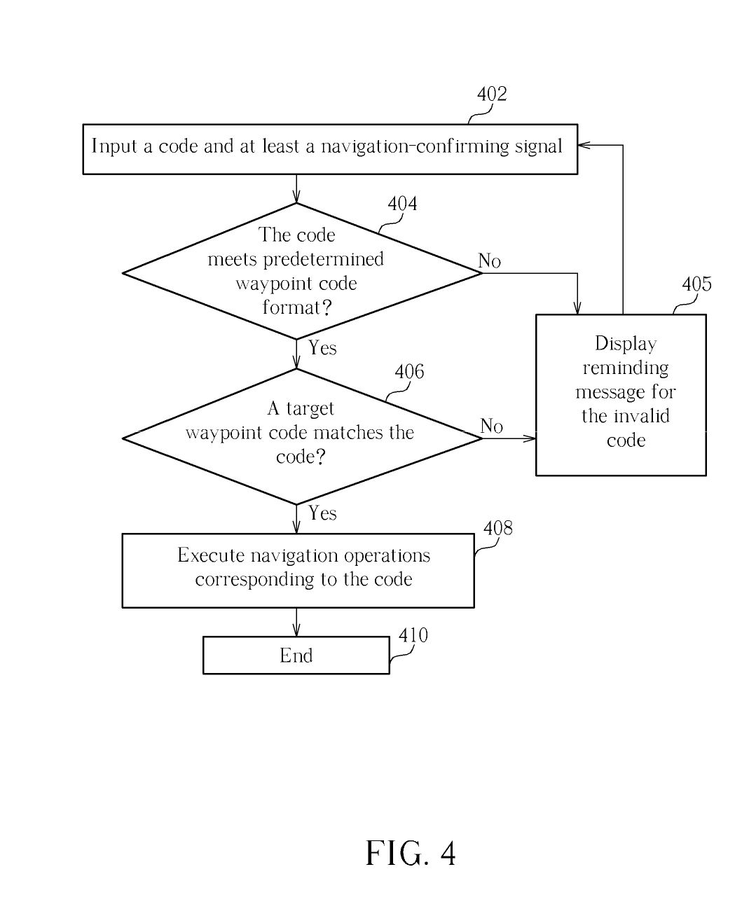

Please refer to FIG. 4 in conjunction with FIG. 1. FIG. 4 is a flowchart illustrating a navigation starting method applied to the electronic device shown in FIG. 1 according to an exemplary embodiment of the present invention. After the user dynamically edits a plurality of target waypoint codes respectively corresponding to the plurality of target waypoints, the GIS database 142 then stores the plurality of target waypoint codes corresponding to the plurality of target waypoints. As a result, the user is capable of activating the navigation operations in a simple and easy manner after the waypoint code editing method of the present invention is executed. In an embodiment of the present invention, the navigation device 100 (i.e., the electronic device) automatically starts demanded navigation operations after the user inputs a code and then inputs at least a navigation-confirming signal at the input unit 112 of the electronic device 100. The steps of the navigation starting method are disclosed as follows. Please note that if the result is substantially the same, the steps are not limited to be executed according to the exact order shown in FIG. 4. The flow includes the following steps:
Step 402: Input a code and input at least a navigation-confirming signal to the electronic device (i.e., navigation device) 100;
Step 404: Determine whether the code meets the predetermined waypoint code format or not. If yes, go to Step 406; otherwise, go to Step 405;
Step 405: Display a reminding message on the output unit 114 for informing the user the code is invalid, and then go to Step 402;
Step 406: Determine if the GIS database 142 has a target waypoint code matching the code. If yes, go to Step 408; otherwise, go to Step 405;
Step 408: The processor 120 enables a navigation module of the electronic device 100 to execute navigation operations corresponding to the code;
Step 410: End.

In Step 404, the processor 120 executes the navigation starting control program 154 stored in the second storage unit 150 to determine if the code meets the predetermined waypoint code format, then the processor 120 searches the GIS database 142 within the first storage unit 140 of the electronic device 100 for a target waypoint code in the GIS database 142 that matches the inputted code. The electronic device 100 will determine there is valid waypoint code matching when the GIS database 142 has the same waypoint code as the code inputted by user. The electronic device 100 therefore controls the processor 120 to enable the navigation module to execute required navigation operations.

In this embodiment, the navigation module contains the positioning system 160, the navigation guidance component 170 and the routing component 180; however, it should be noted that this is not meant to be a limitation of the present invention. In alternative designs of the present invention, the navigation module can be implemented using other combinations of related components that can achieve the same objective of planning routes and starting the navigation operations. These modifications all obey the spirit of the present invention.

In the present invention, the aforementioned waypoint codes are ASCII codes excluding the navigation-confirming signal. For instance, the waypoint codes can be arbitrary combinations of Arabic numerals, English letters or combinations of both types. However, it should be noted that this is not meant to be a limitation of the present invention. In other embodiments of the present invention, other characters and/or symbols can be implemented as waypoint codes. In addition, the length of the waypoint codes varies according to the requirement of the navigation device (i.e., the electronic device 100 in the above disclosure) and requirements of the user.

In the navigation starting flow, inputting the navigation-confirming signal is for informing the electronic device 100 that the code previously inputted is for a navigation operation rather than another use of the electronic device 100. For instance, the electronic device 100 may also have a phone function simultaneously. Therefore, the navigation-conforming signal at this time informs the electronic device 100 that the instantly received code is not a phone number and is for a navigation operation. Another usage of the navigation-confirming signal is for the user to confirm whether to enable the navigation operation or not. In an exemplary case, the navigation device (i.e., the electronic device 100) is applied to a portable phone device (such as a cell phone), and the keystrokes “*” and/or “#” on the portable phone device are utilized to act as the navigation-confirming signal. For instance, in a case where a target waypoint “home” has a corresponding target waypoint code as “1000”, and in this embodiment the predetermined navigation-confirming signal is “#” simultaneously, the user can enable a navigation operation towards the waypoint with waypoint code “home” by inputting “1000#” at the input unit 112. Since, in some embodiments of the present invention, a multi-function electronic device 100 probably has other functions in addition to the navigation function, and some special symbols and digital coding might be designed to serve as quick launch means of certain functions of the electronic device 100, the navigation-confirming signal therefore should be different from other functional codes inherent to the multi-function electronic device. In other words, when setting the predetermined code format, valid waypoint codes are limited to be combinations of letters, numbers, and symbols except functional codes inherent to the multi-function electronic device 100.

Regarding the navigation starting method illustrated in FIG. 4, the first storage unit 140 of the electronic device 100 is implemented to store the plurality of target waypoint codes respectively corresponding to the plurality of target waypoints; the input unit 112 is implemented to receive codes and the navigation-confirming signal inputted by the user; the navigation module is implemented to plan routes for the navigation; and the navigation starting control program 154 in the second storage unit 152 is for the processor 120 to execute the navigation starting flow. In the aforementioned embodiments, the processor 120 chooses a target waypoint code corresponding to the inputted code according to both the code inputted by the user and the plurality of target waypoint codes stored within the GIS database 142, and the processor 120 then controls the navigation module to execute the navigation operation accordingly after finding the corresponding target waypoint. In addition, the processor 120 informs the user that the inputted code is invalid via the output unit 114 when the code inputted by the user is different from all the target waypoint codes in the GIS database 142.

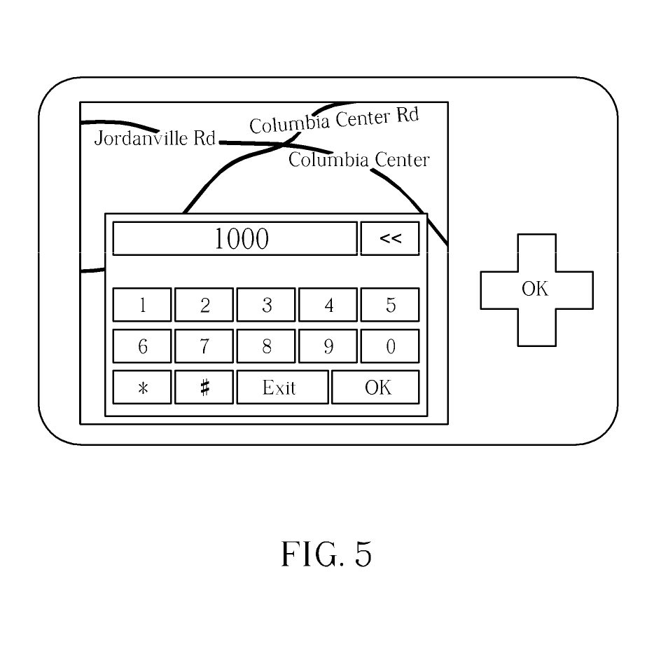

Please refer to FIG. 5 in conjunction with FIG. 4. FIG. 5 is a diagram illustrating an exemplary embodiment of the navigation starting method of FIG. 1 employed on a navigation device (e.g., electronic device 100) without a physical keyboard according to the present invention. As shown in FIG. 5, in a case where the electronic device 100 of the present invention is employed on a navigation device without a phone dialing function, the user activates a virtual keyboard through a specified keystroke or specified functional keystroke and then enables a navigation operation by inputting valid target waypoint codes and navigation-confirming signal on the virtual keystroke as such a navigation device is not equipped with a physical keyboard.

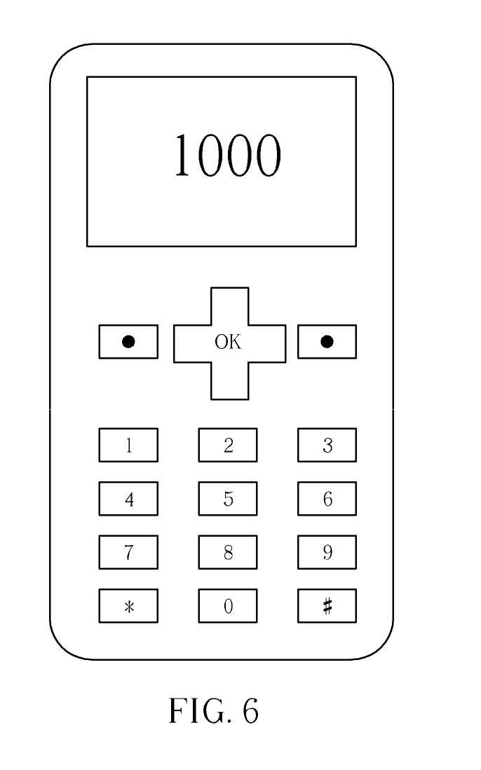

Please refer to FIG. 6 in conjunction with FIG. 4. FIG. 6 is a diagram illustrating a first embodiment of applying the disclosed navigation starting method to an electronic device with a physical keyboard according to the present invention. In this embodiment, the functional keystroke for the navigation-confirming signal is different from functional codes of any other existing functional codes (for example, the navigation-confirming signal is different from the functional keystroke for phone dialing purposes), as the user enables the navigation operation of the target waypoint through inputting a target waypoint code corresponding to the target waypoint at the physical keyboard and then inputting the navigation-confirming signal (such as the functional keystroke “#” at the physical keyboard) to guide the user to arrive at the target waypoint.

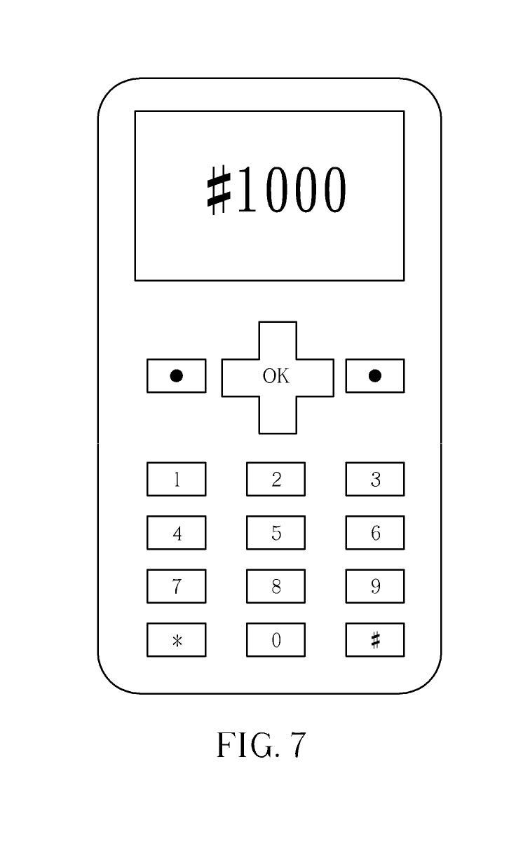

Please refer to FIG. 7 in conjunction with FIG. 4. FIG. 7 is a diagram illustrating a second embodiment of applying the disclosed navigation starting method to an electronic device with a physical keyboard according to the present invention. In this embodiment, the navigation-confirming signal for starting/enabling navigation operations is the same as the functional keystroke of phone dialing, and the user starts the navigation operation through firstly inputting another navigation-confirming signal (i.e., the functional keystroke “#” shown in FIG. 7) to inform the electronic device (i.e., the navigation device) that the inputted code does not represent a general phone number but acts as a target waypoint code. Next, the user inputs a target waypoint code and presses a dialing functional keystroke of the navigation device to activate the navigation corresponding to the target waypoint code.

In conclusion, the electronic device 100 (i.e., navigation device) of the present invention pre-stores the target waypoint codes corresponding to target waypoints, where the target waypoint codes are specified and set by the user. In such a manner, the electronic device 100 of the present invention simplifies the keystroke number of each navigation operation and consequently shortens the required operation time of each navigation operation due to the fact that the electronic device 100, unlike conventional navigation devices, does not have to search the GIS database 142 for a required target waypoint during each navigation process or search the target waypoint by the search function thereof, and the user is not required to memorize the phone number of the target waypoint for starting the navigation.

Those skilled in the art will readily observe that numerous modifications and alterations of the device and method may be made while retaining the teachings of the invention.

What is claimed is:

1. A waypoint code establishing method applied to an electronic device, comprising:
(a) editing at least a target waypoint codes, and respectively assigning the target waypoint code to a target waypoint stored within the electronic device; and
(b) storing the target waypoint code into the electronic device.

2. The method of claim 1, wherein the step (a) comprises:
determining whether the waypoint code meets a waypoint code storing condition to be assigned as a target waypoint code corresponding to the target waypoint.

3. The method of claim 2, wherein the waypoint code storing condition comprises: the waypoint code is not stored within the electronic device.

4. The method of claim 2, wherein the waypoint code-storing condition comprises: the waypoint code meets a predetermined waypoint code format.

5. The method of claim 1, wherein the step (b) stores the target waypoint code into a GIS database of the electronic device.

6. A navigation starting method applied to a navigation device, comprising:
inputting a code to the navigation device, wherein the navigation device has a plurality of target waypoint codes respectively corresponding to a plurality of target waypoints;
choosing a specified target waypoint from the plurality of target waypoints according to the code and the plurality of target waypoint codes; and
automatically starting a navigation operation corresponding to the specified target waypoint after the specified waypoint is chosen.

7. The method of claim 6, wherein the step of inputting the code to the navigation device further comprises:
informing the navigation device that the code is a waypoint code by inputting at least a navigation-confirming signal to the navigation device.

8. The method of claim 6, wherein the plurality of target waypoint codes respectively corresponding to the plurality of target waypoints are stored within a GIS database of the navigation device.

9. An electronic device, comprising:
a processor;
a first storage unit; and
a second storage unit, storing a waypoint code establishment program, wherein the processor executes the waypoint code establishment program to execute following operations:
editing a target waypoint code and assigning the target waypoint code respectively to a target waypoint; and storing the target waypoint code into the first storage unit.

10. The electronic device of claim 9, wherein the processor executes the waypoint code establishment program to determine whether the waypoint code meets a waypoint code storing condition to be assigned as a target waypoint code corresponding to the target waypoint.

11. The electronic device of claim 10, wherein the waypoint code storing condition comprises: the waypoint code is not stored within the electronic device.

12. The electronic device of claim 10, wherein the waypoint code storing condition comprises: the waypoint code meets a predetermined waypoint code format.

13. The electronic device of claim 9, wherein the first storage unit stores a GIS database, and the processor executes the waypoint code establishment program to store the plurality of target waypoint codes into the GIS database.

14. A navigation device, comprising:
a processor;
a first storage unit, storing a plurality of target waypoint codes respectively corresponding to a plurality of target waypoints;
an input unit, for receiving a code;
a navigation module; and
a second storage unit, storing a navigation starting control program, wherein the processor executes the navigation starting control program to execute following operations:
choosing a specified target waypoint from the plurality of target waypoints according to the code and the plurality of target waypoint codes; and automatically starting a navigation operation corresponding to the specified target waypoint after the specified target waypoint is chosen.

15. The navigation device of claim 14, wherein the input unit further informs the navigation device that the code is a waypoint code by receiving at least one navigation-confirming signal.

16. The navigation device of claim 14, wherein the first storage unit stores a GIS database, and the plurality of target waypoint codes corresponding to the plurality of target waypoints are stored within the GIS database.
